(19) United States
(12) Patent Application Publication
(10) Pub. No.: US 2024/0129613 A1
(43) Pub. Date: Apr. 18, 2024

(54) LENS FOCUSING CONTROL METHOD AND DEVICE, PHOTOGRAPHING DEVICE

(71) Applicant: SZ DJI TECHNOLOGY CO., LTD., Shenzhen (CN)

(72) Inventor: Xuyang FENG, Shenzhen (CN)

(73) Assignee: SZ DJI TECHNOLOGY CO., LTD., Shenzhen (CN)

(21) Appl. No.: 18/395,070

(22) Filed: Dec. 22, 2023

Related U.S. Application Data
(63) Continuation of application No. PCT/CN2021/101966, filed on Jun. 24, 2021.

(51) Int. Cl. H04N 23/61; G02B 7/08; G02B 7/36; H04N 23/62; H04N 23/67

(52) U.S. Cl. CPC H04N 23/61; G02B 7/08; G02B 7/36; H04N 23/62; H04N 23/67

(57) ABSTRACT

A lens focusing control method and device, and a photographing device are provided. The device includes at least one processor and at least one memory including computer program code, the at least one memory and the computer program code are configured, with the at least one processor, to cause the device to at least: obtain an operation and determine a target object to be focused based on the operation, and control, based on a current focus position of a lens and a target focusing speed, the lens to automatically focus from the current focus position to a target object.

### RELATED APPLICATIONS

This application is a continuation application of PCT application No. PCT/CN2021/101966, filed on Jun. 24, 2021, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of lens control, and in particular to a lens focusing control method and device, and a photographing device.

### BACKGROUND

For most photographing devices, video recording or photo taking requires focusing to ensure that the object being photographed is clear.

Manual focus controls the forward and backward movement of a focus plane by manually twisting a focus ring or follow focus device on the lens. At the same time, by observing the sharpness of a target or a highlighted peak focus assist pattern on a screen, a user can judge whether the focus position of the lens is on the target being photographed.

Automatic focus is currently assisted by algorithms such as face recognition and target tracking, as well as ranging methods such as PDAF and TOF to quickly lock the focus on a specific target and capture clear photos.

### SUMMARY

The present disclosure provides a lens focusing control method and device, and a photographing device.

Specifically, the present disclosure can be achieved by the following technical solutions.

In an aspect, embodiments of the present disclosure provide a lens focusing control device, including at least one processor; and at least one memory including computer program code, wherein the at least one memory and the computer program code are configured, with the at least one processor, to cause the device to at least: obtain an operation and determine a target object to be focused based on the operation, and control, based on a current focus position of a lens and a target focusing speed, the lens to automatically focus from the current focus position to a target object.

In another aspect, embodiments of the present disclosure provide a photographing device, including: a lens; and a lens focusing control device, including: at least one processor, and at least one memory including computer program code, wherein the at least one memory and the computer program code are configured, with the at least one processor, to cause the device to at least: obtain an operation and determine a target object to be focused based on the operation, and control, based on a current focus position of a lens and a target focusing speed, the lens to automatically focus from the current focus position to a target object.

In yet another aspect, embodiments of the present disclosure provide a lens focusing control method, including: obtaining an operation and determining a target object to be focused based on the operation; and controlling, based on a current focus position of a lens and a target focusing speed, the lens to automatically focus from the current focus position to the target object.

According to the technical solutions provided by exemplary embodiments of the present disclosure, the present disclosure allows determining a target object to be focused based on a user's operation, and then controlling a lens to automatically focus from a current focus position to a target object based on a target focusing speed. With an automatic assist algorithm, video recording and photo taking can have the flexibility and controllability comparable to those of manual focus, but also has the accuracy and ease of use of automatic focus.

### BRIEF DESCRIPTION OF THE DRAWINGS

In order to describe the technical solutions in some exemplary embodiments of the present disclosure, the drawings for the description of the exemplary embodiments will be briefly described below.

FIG. 1 is a schematic flow chat of a lens focusing control method according to some exemplary embodiments of the present disclosure;

FIG. 2 is a schematic structural diagram of a photographing device according to some exemplary embodiments of the present disclosure;

FIG. 3 is a schematic diagram of a process of determining a target object to be focused among a plurality of objects based on a user operation according to some exemplary embodiments of the present disclosure;

FIG. 4 is a schematic diagram of a process of determining a target object to be focused among a plurality of objects based on a user operation according to some exemplary embodiments of the present disclosure;

FIG. 5 is a schematic diagram of a process of determining a target object to be focused among a plurality of objects based on a user operation according to some exemplary embodiments of the present disclosure;

FIG. 6 is a schematic diagram of a process of determining a target object to be focused among a plurality of objects based on a user operation according to some exemplary embodiments of the present disclosure; and

FIG. 7 is a schematic structural diagram of a lens focusing control device according to some exemplary embodiments of the present disclosure.

### DETAILED DESCRIPTION

Since the selection of the focus area for autofocus is automatically selected by the algorithm, in the case where the target is lost or the focus target needs to be changed, although the performance of the algorithm can have different rules, there is still a certain degree of randomness. It thus falls short of user expectations and lacks necessary controllability. In film and television shooting where every frame is important, the uncertainty and low controllability of the automatic focus method are even more intolerable. Therefore, almost all professional film and television shootings may employ professional “follow-focus instructors” for focusing in the MF (manual focus, MF) mode in order to achieve the purpose of expressing creative contents with the focus position. A professional “follow-focus instructor” needs long-term professional training. However, due to reasons such as the limited accuracy of human hands and the limited ability of human eyes to observe details, during shooting, a person often needs to practice preparations in advance, manually measure distances, mark focus positions in advance, and other preparation procedures. It is even more difficult when the target is constantly in motion. Although the focusing action may be smooth, the focusing effect of each frame may not be optimal. For the growing requirements for picture clarity (4 k, 8 k, etc.), automatic focus is difficult to match them.

In light of the foregoing, according to the present disclosure, a target object to be focused can be determined based on a user operation, and then based on a target focusing speed, a lens can be controlled to automatically focus from a current focus position to a target object. With an automatic assist algorithm, it allows video recording and photo taking to not only have the flexibility and controllability comparable to those of manual focus, but also have the accuracy and ease of use of automatic focus.

The technical solutions in some exemplary embodiments of the present disclosure will be described below with reference to the drawings of the exemplary embodiments of the present disclosure.

It should be noted that, as long as there is no conflict, the features in the following exemplary embodiments and implementation modes may be combined with one another.

In the present disclosure, “at least one” refers to one or more; “a plurality of” refers to two or more; “and/or” refers to the relationship between related objects, indicating that there can be three relationships; for example, A and/or B may refers to: A alone, both A and B, and B alone, where A and B can be singular or plural. The character “/” generally indicates that the related objects are in an “or” relationship. “At least one of the following” or similar expressions refers to any combination of the items, including any combination of single items (elements) or plural items (elements). For example, at least one of a, b, or c may mean: a, b, c; a and b; a and c; b and c; or a, b and c, where a, b and c can be single or plural.

In some exemplary embodiments of the present disclosure, the photographing device can include a lens, which may be a manual lens or an automatic lens.

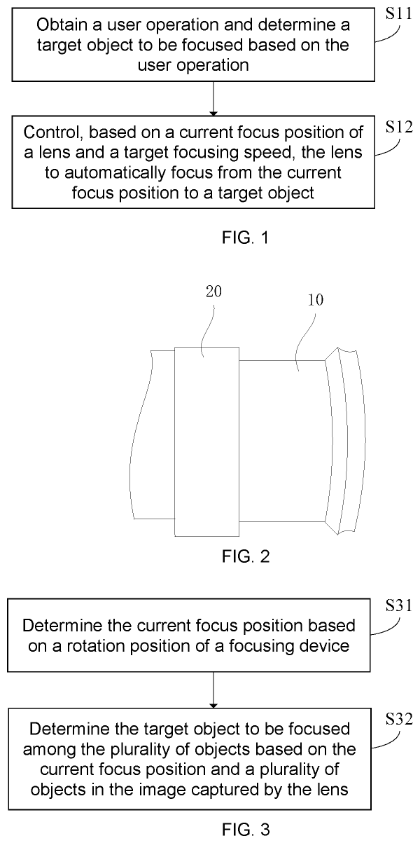

FIG. 1 is a schematic flow chat of a lens focusing control method according to some exemplary embodiments of the present disclosure. In some exemplary embodiments of the present disclosure, the performer of the lens focusing control method may be a photographing device, an independent controller provided for the photographing device, a control device of the photographing device, or a combination of the above. Referring to FIG. 1, the lens focusing control method of according to some exemplary embodiments of the present disclosure may include steps S11 to S12.

S11. Obtain a user operation and determine a target object to be focused based on the user operation.

The user operation herein may include a focusing operation on a lens or a touching operation on an image captured by a lens.

For example, in some exemplary embodiments of the present disclosure, the user operation can be a manual lens focusing operation. In some exemplary embodiments, when performing a lens focusing operation, the lens can be adjusted for focusing based on a manual method by the user, which is highly flexible and controllable. A user can control the switching of the focus target and the movement of the focus during the switching process (such as focusing speed, etc.) to the greatest extent. Specifically, the lens focusing operation may include rotating a focusing device of the lens. The focusing device may include a focus ring of the lens or a follow focus device of the lens, but is not limited thereto. As shown in FIG. 2, the user can rotate the focus ring 20 of the lens to adjust the focus of the lens 10; in another example, the user may rotate the follow focus device of the lens to adjust the focus of the lens.

In some exemplary embodiments of the present disclosure, the target focusing speed herein can be obtained based on the focusing speed of a focusing device in the manual focusing stage. The focusing speed of the focusing device in the manual focusing stage can include an average focusing speed of the focusing device during the entire manual focusing stage, an average focusing speed of the focusing device within a first preset time period, or a focusing speed of the focusing device at a first preset time point. The first preset time point herein includes a last time point of the manual focus stage. This ensures that the focus can move smoothly to the target object when switching between manual focus and automatic focus. It should be understood that the first preset time period and the first preset time point are both within the manual focusing stage.

In some exemplary embodiments of the present disclosure, the target focusing speed can be obtained based on the rotation speed of the focusing device in the manual focusing stage. The rotation speed of the focusing device in the manual focusing phase includes an average rotation speed of the focusing device during the entire manual focusing stage, an average rotation speed of the focusing device within to second preset time period, or a rotation speed of the focusing device at a second preset time point. The second preset time point can include the last time point of the manual focus stage. This ensures that the focus can move smoothly to the target object when switching between manual focus and automatic focus. It should be understood that the second preset time period and the second preset time point are both within the manual focusing stage.

For example, the target focusing speed can be determined based on the rotation speed. In some exemplary embodiments, the target focusing speed can be the rotation speed. In some exemplary embodiments, the target focusing speed is not equal to the rotation speed.

In some exemplary embodiments of the present disclosure, the user operation can be a touching operation on an image captured by the lens. The touching operation can include a click operation or a frame selection operation, but is not limited thereto. For example, the photographing device has a display screen, and the display screen displays an image captured by the lens. The user may click the image to select the target object, or frame the target object in the image. In some exemplary embodiments, the target focusing speed is preset. In some exemplary embodiments, after the target focusing speed is preset, the target focusing speed can be reset by the user. In some exemplary embodiments, after the target focusing speed is preset, the target focusing speed cannot be reset by the user.

Next, the implementation process of determining the target object to be focused based on the user operation in S11 will be described in detail below.

In some exemplary embodiments of the present disclosure, the lens focusing control method may further include: obtaining an image captured by the lens, and identifying a plurality of objects in the image, where existing image recognition algorithms can be used to identify objects. The objects herein may include people, animals, vehicles and other objects that the user is interested in for photographing. Herein, the target object to be focused among the plurality of objects can be determined according to the user operation, and the target object is one of the plurality of objects identified in the image.

The determining of the target object to be focused among the plurality of objects according to the user operation can be implemented in different ways.

For example, in some exemplary embodiments, as shown in FIG. 3, the determining of the target object to be focused among the plurality of objects according to the user operation may include the following steps.

S31. Determine the current focus position based on a rotation position of the focusing device.

In some exemplary embodiments, the current focus position is determined based on calculating with the rotation position of the focusing device; or, after rotating the focusing device, the current focus position is obtained based on a current image.

S32. Determine the target object to be focused among a plurality of objects based on the current focus position and a plurality of objects in the image captured by the lens.

In some exemplary embodiments, the target object to be focused is determined based on the distances between the plurality of objects and the current focus position.

For example, in some exemplary embodiments, the target object is the object with the smallest distance from the current focus position among the plurality of objects. In some exemplary embodiments, the object with the smallest distance from the current focus position among the plurality of objects is determined, and when the distance between the object with the smallest distance from the current focus position among the plurality of objects and the current focus position is less than a preset threshold, this object is determined to be the target object to be focused.

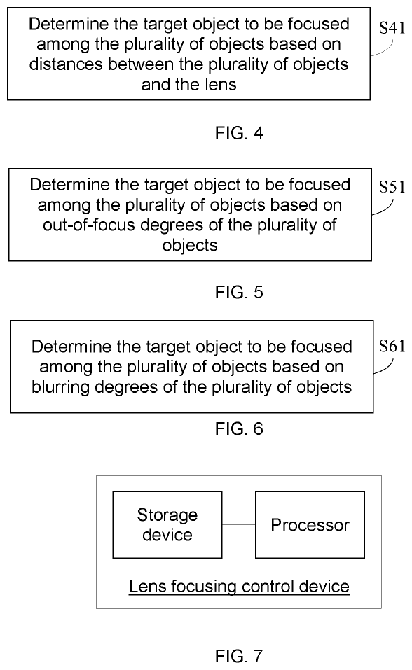

In some exemplary embodiments, as shown in FIG. 4, the determining of the target object to be focused among the plurality of objects based on the user operation may include:

S41. Determine the target object to be focused among the plurality of objects based on distances between the plurality of objects and the lens. For example, the object with the smallest distance from the lens among plurality of objects can be selected as the target object. The distances between the plurality of objects and the lens can be detected and obtained with a ranging sensor of the photographing device, such as a TOF (time of flight) sensor, but it is not limited thereto.

In some exemplary embodiments, as shown in FIG. 5, the determining of the target object to be focused among the plurality of objects based on the user operation may include:

S51. Determine the target object to be focused among the plurality of objects based on out-of-focus degrees of the plurality of objects. For example, a user can select the object with the smallest out-of-focus degree among the plurality of objects as the target object.

In some exemplary embodiments, as shown in FIG. 6, the determining of the target object to be focused among the plurality of objects based on the user operation may include:

S61. Determine the target object to be focused among the plurality of objects based on blurring degrees of the plurality of objects. For example, a user can select the object with the smallest blurring degree among plurality of objects as the target object.

It should be understood that at least two of the following factors: the distances between the plurality of objects and the current focus position, the distances between the plurality of objects and the lens, the out-of-focus degrees of the plurality of objects and the blurring degrees of the plurality of objects, can be comprehensively considered, so as to determine the target object to be focused among the plurality of objects. For example, at least two of the distances between the plurality of objects and the current focus position, the distances between the plurality of objects and the lens, the out-of-focus degrees of the plurality of objects and the blurring degrees of the plurality of objects can be weighted to obtain weighted values of the plurality of objects; then among the plurality of objects, the object with the smallest weight value can be used as the target object.

In some exemplary embodiments, the target object to be focused can be determined based solely on the user operation. In some exemplary embodiments, the lens focusing control method may further include: perform a following operation on the plurality of objects to obtain following information of the plurality of objects. The following information may include at least one of the distances between the plurality of objects and the lens, the out-of-focus degrees of the plurality of objects, and the blurring degrees of the plurality of objects. The distances between the plurality of objects and the lens can be detected and obtained with a ranging sensor of the photographing device, such as a TOF sensor, but the present disclosure is not limited thereto. In some exemplary embodiments, the target object to be focused among the plurality of objects can be determined based on the user operation and the following information of the plurality of objects.

S12. Control, based on a current focus position of a lens and a target focusing speed, the lens to automatically focus from the current focus position to a target object.

Specifically, the lens is controlled to automatically focus from the current focus position to the target object at the target focusing speed, thereby smoothly and accurately moving the focus of the lens to the target object. For example, when the target focusing speed is the focusing speed of the focusing device in the manual focusing stage (including the average focusing speed of the focusing device during the entire manual focusing stage, the average focusing speed of the focusing device within the first preset time period, or the focusing speed of the focusing device at the first preset time point) or the rotation speed of the focusing device in the manual focusing stage (including the average rotation speed of the focusing device during the entire manual focusing stage, the average rotation speed of the focusing device during the second preset time period, or the rotation speed of the focusing device at the second preset time point), the user's manual operation on the focusing device can be simulated to achieve automatic focusing. In another example, when the target focusing speed is preset, the lens can be controlled to automatically focus from the current focus position to the target object at the preset target focusing speed to meet the user's demand for focusing speed.

In some exemplary embodiments, the lens focusing control method of may further include: during the manual focusing process, identifying the target object in an image captured by the lens by a preset identification method, where the identification method includes highlighting identification, framing identification and patterning identification. In some exemplary embodiments, after step S11 and before step S12, the target object can be highlighted in the image captured by the lens. The user can be prompted by highlighting the target object. The user can determine whether the currently highlighted target object is the object to be focused based on the image. The specific way the target object is highlighted in the image captured by the lens can be selected as needed. For example, a highlight mark, such as a circle or another mark, can be provided at a center of the target object in the image captured by the lens.

In some exemplary embodiments, when the user operation stops, the lens can be controlled to automatically focus from the current focus position to the target object based on the current focus position of the lens and the target focusing speed. That is, when the user operation stops, automatic focus is performed to ensure pixel-level accuracy. In some exemplary embodiments, when the user operation stops and the target object is highlighted in the image captured by the lens, the lens is controlled, based the current focus position of the lens and the target focusing speed, to automatically focus from the current focus position to the target object to ensure the accuracy of focus.

In some exemplary embodiments, after controlling the lens to automatically focus from the current focus position to the target object according to the current focus position of the lens and the target focusing speed and prior to obtaining a new user operation, the lens can be controlled to continuously focus on the target object automatically. That is, after obtaining the current user operation and prior to the next operation from the user, the lens can be to continuously lock the target object by automatic focus.

In some exemplary embodiments, the lens focusing control method may further include: when the target object is lost from the image captured by the lens, controlling the current focus position of the lens to remain at the position before the target object is lost. When the target object is lost, if there is no any user operation, the current focus position of the lens can stay at the position before the target object is lost without changing. If a new user operation is obtained, the process can be similar to the above steps S11 to S12. The user has complete control over manual focus, with automatic focus only taking over when the user operation ceases.

In some exemplary embodiments, the automatic focus includes one of PDAF (phase detection auto focus), CDAF (contrast detection auto focus), or TOF (time of flight) focus. For example, according to the current focus position of the lens and the target focusing speed, the lens can be controlled to automatically focus from the current focus position to the target object based on the PDAF focusing method, or according to the current focus position of the lens and the target focusing speed, the lens can be controlled to automatically focus from the current focus position to the target object based on the TOF focusing method. Of course, the automatic focus method is not limited to the methods listed herein, and can be another automatic focus method.

The lens focusing control method of the present disclosure can be applied to film and television shooting, such as film and television shooting of movies, TV series, etc., and can also be applied to other types of video shooting. Therefore, based on an automatic assist algorithm, photo taking and video recording can have the flexibility and controllability comparable to those of manual focus, as well as the accuracy and ease of use of automatic focus.

Referring to FIG. 7, some exemplary embodiments of the present disclosure further provides a lens focusing control device. The device includes a storage device and one or more processors.

The storage device is configured to store program instructions. The storage device stores an executable instruction computer program(s) for the lens focusing control method. The storage device may include at least one type of storage medium, and the storage medium can include flash memory, hard disk, multimedia card, card-type memory (for example, SD or DX memory, etc.), random access memory (RAM), static random access memory (SRAM), read-only memory (ROM), electrically erasable programmable read-only memory (EEPROM), programmable read-only memory (PROM), magnetic memory, magnetic disk, optical disk, and the like. Furthermore, the lens focusing control device may cooperate with a network storage device that performs the storage function via a network connection. The storage device may be an internal storage unit of the lens focusing control device, such as a hard disk or memory of the lens focusing control device. The storage device can also be an external storage device of the lens focusing control device, such as a plug-in hard drive equipped on the lens focusing control device, a smart media card (SMC), a secure digital (SD) card, a Flash card, etc. In addition, the storage device can include both an internal storage unit of the lens focusing control device and an external storage device. The storage device is configured to store computer programs and other programs and data required by the device. The storage device can also be used to temporarily store data that has been output or is to be output.

The one or more processors are configured to invoke program instructions stored in the storage device. When the program instructions are executed, the one or more processors, individually or jointly, are used to: obtain a user operation and determine a target object to be focused based on the user operation; and then control, based on a current focus position of a lens and a target focusing speed, the lens to automatically focus from the current focus position to the target object.

The processors herein can implement the lens focusing control method of the exemplary embodiments shown in FIG. 1 and FIG. 3-6 of the present disclosure. The lens focusing control device herein may be described with reference to the lens focusing control method of the previous exemplary embodiments.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Some exemplary embodiments of the present disclosure also provide a photographing device, which may include a lens and a lens focusing control device as described in the previous exemplary embodiments.

In addition, some exemplary embodiments of the present disclosure also provide a computer-readable storage medium on which a computer program is stored, and when the program is executed by a processor(s), the steps of the lens focusing control method of the previous exemplary embodiments can be executed.

The computer-readable storage medium may be an internal storage unit of the photographing device described in any of the previous exemplary embodiments, such as a hard disk or a memory. The computer-readable storage medium may also be an external storage device of the photographing device, such as a plug-in hard disk, a smart media card (SMC), an SD card, a Flash card, etc. equipped on the device. Further, the computer-readable storage medium may also include both an internal storage unit of the photographing device and an external storage device. The computer-readable storage medium can be used to store the computer programs and other programs and data required by the photographing device; it can also be used to temporarily store data that has been output or is to be output.

A person of ordinary skill in the art can understand that all or part of the processes in implementing the methods of the above exemplary embodiments can be completed by instructing relevant hardware via computer program(s). The program(s) can be stored in a computer-readable storage medium. When executed, the program(s) may include the processes of the above method embodiments. The storage medium can be a magnetic disk, an optical disk, a read-only memory (ROM), a random access memory (RAM), etc.

The above disclosures are merely some exemplary embodiments of the present disclosure, and certainly cannot be used to limit the scope of the present disclosure. Therefore, equivalent changes made in accordance with the claims of the present disclosure still fall within the scope of the present disclosure.

What is claimed is:

1. A lens focusing control device, comprising:
at least one processor; and
at least one memory including computer program code, wherein the at least one memory and the computer program code are configured, with the at least one processor, to cause the device to at least:
obtain an operation and determine a target object to be focused based on the operation, and
control, based on a current focus position of a lens and a target focusing speed, the lens to automatically focus from the current focus position to a target object.

2. The device according to claim 1, wherein the at least one memory and the computer program code are further configured, with the at least one processor, to cause the device to at least:
obtain an image captured by the lens, and identify a plurality of objects in the image, wherein
to determine of the target object to be focused based on the operation, the at least one memory and the computer program code are further configured, with the at least one processor, to cause the device to at least:
determine the target object to be focused among the plurality of objects based on the operation.

3. The device according to claim 2, wherein to determine the target object to be focused among the plurality of objects based on the operation, the at least one memory and the computer program code are further configured, with the at least one processor, to cause the device to at least:
perform a following operation on the plurality of objects to obtain following information of the plurality of objects, and determine, based on the operation and the following information of the plurality of objects, the target object to be focused among the plurality of objects;
determine the current focus position based on a rotation position of a focusing device, and determining, based on the current focus position and the plurality of objects in the image captured by the lens, the target object to be focused among the plurality of objects;
determine, based on distances between the plurality of objects and the lens, the target object to be focused among the plurality of objects;
determine, based on out-of-focus degrees of the plurality of objects, the target object to be focused among the plurality of objects; or
determine, based on blurring degrees of the plurality of objects, the target object to be focused among the plurality of objects.

4. The device according to claim 1, wherein to control, based on the current focus position of the lens and the target focusing speed, the lens to automatically focus from the current focus position to the target object, the at least one memory and the computer program code are further configured, with the at least one processor, to cause the device to at least:
when the operation stops, control, based on the current focus position of the lens and the target focusing speed, the lens to automatically focus from the current focus position to the target object.

5. The device according to claim 1, wherein after controlling, based on the current focus position of the lens and the target focusing speed, the lens to automatically focus from the current focus position to the target object, the at least one memory and the computer program code are further configured, with the at least one processor, to cause the device to at least:
control the lens to continuously focus on the target object automatically prior to obtaining a new operation.

6. The device according to claim 1, wherein the operation includes a focusing operation on the lens.

7. The device according to claim 6, wherein the focusing operation on the lens includes a manual lens focusing operation.

8. The device according to claim 6, wherein the target focusing speed is obtained based on a focusing speed of a focusing device in the manual lens focusing process.

9. The device according to claim 1, wherein the operation includes a touching operation on an image captured by the lens.

10. The device according to claim 1, wherein the at least one memory and the computer program code are further configured, with the at least one processor, to cause the device to at least:
identify, during a manual focusing process, the target object in an image captured by the lens by a preset identification method.

11. The device according to claim 1, wherein to control, based on the current focus position of the lens and the target focusing speed, the lens to automatically focus from the current focus position to the target object, the at least one memory and the computer program code are further configured, with the at least one processor, to cause the device to at least:
when the operation stops, control, based on the current focus position of the lens and the target focusing speed, the lens to automatically focus from the current focus position to the target object.

12. The device according to claim 11, the at least one memory and the computer program code are further configured, with the at least one processor, to cause the device to at least:
control, prior to obtaining a new operation, the lens to continuously focus on the target object automatically, after controlling the lens to automatically focus from the current focus position to the target object based on the current focus position of the lens and the target focusing speed.

13. The device according to claim 12, the at least one memory and the computer program code are further configured, with the at least one processor, to cause the device to at least:
upon losing the target object from an image captured by the lens, control the current focus position of the lens to remain at a position preceding losing the target object.

14. The device according to claim 1, wherein the lens is controlled to automatically focus by a focusing method of phase detection auto focus (PDAF), contrast detection auto focus (CDAF), or time of flight (TOF) focus.

15. A photographing device, comprising:
a lens; and
a lens focusing control device, including:
at least one processor, and
at least one memory including computer program code, wherein the at least one memory and the computer program code are configured, with the at least one processor, to cause the device to at least:
obtain an operation and determine a target object to be focused based on the operation, and
control, based on a current focus position of a lens and a target focusing speed, the lens to automatically focus from the current focus position to a target object.

16. A lens focusing control method, comprising:
obtaining an operation and determining a target object to be focused based on the operation; and
controlling, based on a current focus position of a lens and a target focusing speed, the lens to automatically focus from the current focus position to the target object.

17. The method according to claim 16, further comprising:
obtaining an image captured by the lens, and identifying a plurality of objects in the image, wherein
the determining of the target object to be focused based on the operation includes:
determining the target object to be focused among the plurality of objects based on the operation.

18. The method according to claim 17, wherein the determining the target object to be focused among the plurality of objects based on the operation includes at least one of:
performing a following operation on the plurality of objects to obtain following information of the plurality of objects, and determining, based on the operation and the following information of the plurality of objects, the target object to be focused among the plurality of objects;
determining the current focus position based on a rotation position of a focusing device, and determining, based on the current focus position and the plurality of objects in the image captured by the lens, the target object to be focused among the plurality of objects;
determining, based on distances between the plurality of objects and the lens, the target object to be focused among the plurality of objects;
determining, based on out-of-focus degrees of the plurality of objects, the target object to be focused among the plurality of objects; or
determining, based on blurring degrees of the plurality of objects, the target object to be focused among the plurality of objects.

19. The method according to claim 18, wherein the determining, based on the current focus position and the plurality of objects in the image captured by the lens, the target object to be focused among the plurality of objects includes:
determining the target object to be focused based on distances between the plurality of objects and the current focus position.

20. The method according to claim 19, wherein the determining the target object to be focused based on distances between the plurality of objects and the current focus position includes:
determining an object with a smallest distance from the current focus position among the plurality of objects; and
determining, when the smallest distance is less than a preset threshold, the object with the smallest distance as the target object to be focused.
